(19) United States
(12) Patent Application Publication
(10) Pub. No.: US 2026/0097351 A1
(43) Pub. Date: Apr. 9, 2026

(54) CARTRIDGE FOR CAPTURING CO2

(71) Applicant: SAFRAN AEROSYSTEMS, Plaisir (FR)

(72) Inventors: Thomas Braunlich, Moissy Cramayel (FR); Jean-Marc Debernard, Moissy Cramayel (FR)

(73) Assignee: SAFRAN AEROSYSTEMS, Plaisir (FR)

(21) Appl. No.: 19/405,973

(22) Filed: Dec. 2, 2025

Related U.S. Application Data
(63) Continuation of application No. PCT/FR2024/050696, filed on May 30, 2024.

(30) Foreign Application Priority Data
Jun. 2, 2023 (FR) 23/05562

(51) Int. Cl. B01D 53/04

(52) U.S. Cl. CPC B01D 53/0415; B01D 53/0446; B01D 2253/112; B01D 2257/504; B01D 2259/4541

(57) ABSTRACT

A cartridge for capturing or absorbing CO2 from a user's breath includes a storage space for an adsorbent product (P) to adsorb CO2. The product is in the form of grains, in particular soda lime. The storage space includes a bottom and an opening opposite the bottom, and a compression member arranged on the side of the opening in the storage space. The compression member is movable in the storage space towards the bottom and may tamp down the adsorbent product in the form of grains against the bottom of the storage space. The storage space includes a spring that may exert a force on the compression member tending to push the compression member towards the bottom of the storage space.

### CROSS-REFERENCE TO RELATED APPLICATIONS

This application is a continuation of International Application No. PCT/FR2024/050696, filed on May 30, 2024, which claims priority to and the benefit of French Patent Application No. 23/05562 filed on June 2, 2023. The disclosures of the above applications are incorporated herein by reference.

### FIELD

The present disclosure relates to a cartridge for capturing CO2 for equipping a protective hood.

### BACKGROUND

The statements in this section merely provide background information related to the present disclosure and may not constitute prior art.

Patent application EP2979561 discloses a hood comprising a sealed flexible shell intended to be put on the head of a user, the flexible shell being provided with a transparent window and comprising, in its lower part, a rigid base element of generally annular shape intended to be disposed around the neck of the user. The base element comprises a tubular oxygen tank provided with a calibrated outlet orifice emerging into the internal volume of the flexible shell. This type of device is used on board aircraft when the cabin atmosphere is polluted (depressurization, smoke, chemical agents, etc.). This equipment may allow the crew members to combat the issues, rescue passengers, and manage a potential evacuation of the aircraft.

### SUMMARY

This section provides a general summary of the disclosure and is not a comprehensive disclosure of its full scope or all of its features.

The present disclosure aims in particular to improve a cartridge for capturing CO2 of such a hood.

The present disclosure thus relates to a cartridge for capturing CO2, configured to adsorb the CO2 resulting from the respiration of the user, this cartridge comprising: a space for storing an adsorbent product capable of adsorbing CO2, this product being in the form of grains, the storage space comprising a bottom and an opening opposite this bottom, a compression member disposed on the side of the opening of the storage space, which is movable within the storage space towards the bottom and configured to compact the adsorbent product in the form of grains against the bottom of the storage space, a spring configured to exert a force on the compression member tending to push the compression member towards the bottom of the storage space.

According to one of the aspects of the present disclosure, the storage space is defined between an external lateral wall and an internal lateral wall.

According to one of the aspects of the present disclosure, the internal and external lateral walls are coaxial.

According to one of the aspects of the present disclosure, the internal and external lateral walls are perforated. This allows ambient CO2 to pass through the external lateral wall, encounter the lime grains, be adsorbed onto the lime, and the air thus purified of CO2 then passes through the internal lateral wall to be "drawn in" by a Venturi-effect device at the outlet of an internal duct of the cartridge for capturing CO2, and returned to the internal volume of the hood.

The perforations can take on any type of suitable shapes.

According to one of the aspects of the present disclosure, the internal and external lateral walls are cylindrical, with a circular or oval perimeter or an oblong perimeter.

According to one of the aspects of the present disclosure, the internal and external lateral walls have substantially identical heights.

According to one of the aspects of the present disclosure, the product in the form of grains is stored between the internal and external lateral walls. In other words, the storage space has a generally annular shape.

According to one of the aspects of the present disclosure, the external lateral wall is formed on a cylinder.

According to one of the aspects of the present disclosure, the bottom wall of the storage space is formed on this cylinder.

According to one of the aspects of the present disclosure, the internal lateral wall and the external lateral wall are formed on two separate pieces which are assembled.

According to one of the aspects of the present disclosure, the compression member has an annular shape with a central opening allowing the compression member to be engaged around the internal lateral wall.

Thus, the internal lateral wall can serve to guide the compression member during a displacement of this compression member in the storage space.

According to one of the aspects of the present disclosure, the compression member is in the form of a washer inserted around the internal lateral wall.

According to one of the aspects of the present disclosure, the washer is flat.

According to one of the aspects of the present disclosure, the external lateral wall receives, at its end bordering the opening, a mounting skirt.

According to one of the aspects of the present disclosure, the mounting skirt extends to a predetermined height from the opening of the storage space.

According to one of the aspects of the present disclosure, the compression member has an outer perimeter which is fitted to the shape of this mounting skirt.

According to one of the aspects of the present disclosure, the cartridge further includes a cover configured to close the opening of the storage space.

According to one of the aspects of the present disclosure, the cover is configured to be fastened to the external lateral wall.

According to one of the aspects of the present disclosure, the cover includes an annular groove that fastens to the external lateral wall and to the mounting skirt.

According to one of the aspects of the present disclosure, the mounting skirt includes a recess configured to receive a sealing gasket bearing against the external lateral wall.

According to one of the aspects of the present disclosure, the compression member is made of plastic or metal.

According to one of the aspects of the present disclosure, the spring is a multi-coil wave spring.

According to one of the aspects of the present disclosure, the spring is made of metal.

According to one of the aspects of the present disclosure, the spring includes a plurality of wave coils stacked on one another.

At the beginning of the service life of the cartridge (for example, when stored on board an aircraft for use), the product in the form of grains has not yet undergone any compaction, for example due to vibrations to which cartridge is subjected. The volume initially occupied by the product is therefore maximal, and the compression member is located as close as possible to the opening of the storage space. During the service life of the product, vibrations may cause fragmentation of the grains of the adsorbent product, potentially leading to the breakdown of some grains into fine particles. This has the effect of reducing the volume occupied by the adsorbent product in the storage space. The compression member, which is pushed by the spring, then moves away from the opening and towards the bottom of the storage space.

It is therefore possible to define a height H1 between the compression member and the cover, in an initial position (for example at the beginning of the service life of the cartridge) in which the compression member is located as close as possible to the cover.

It is also possible to define a height H2 between the compression member and the cover after a storage period of the cartridge or period during which the cartridge may have been subjected to vibrations that caused some compaction of the grains of the adsorbent product. This height H2 is greater than the height H1, reflecting the fact that the compression member moves towards the bottom. This period is, for example, 10 years.

According to one of the aspects of the present disclosure, the heights H1 and H2 are selected so that the force of the spring is always greater than the weight of the adsorbent product subjected to the accelerations generated by the vibrations.

According to one of the aspects of the present disclosure, the stiffness of the spring is selected so that after a predetermined storage period (for example on board an aircraft in service), the height H2 still allows the compression member to provide a satisfactory compaction of the grains of the adsorbent product.

According to one of the aspects of the present disclosure, the compression member and the spring are selected so that the stroke of the compression member, throughout the storage period, is sufficient to maintain the satisfactory compaction of the grains.

In the case where a mounting skirt is inserted on the top of the external lateral wall, the height H2 can be selected to be substantially equal to the height of this mounting skirt so that the compression member moves opposite this mounting skirt, and in case of maximum compaction of the product during its service life, the compression member does not descend below this mounting skirt.

In one example of the present disclosure, the spring is simply placed on the compression member.

According to one of the aspects of the present disclosure, the spring has coils which are placed around the internal lateral wall.

According to one of the aspects of the present disclosure, the spring bears at one end on the cover and at the other end on the compression member.

According to one of the aspects of the present disclosure, the spring is a piece separate from the compression member, which are for example made of different materials.

Alternatively, the spring and the compression member are integrally formed, i.e. in one piece.

According to one of the aspects of the present disclosure, the wave spring with multiple metal coils is particularly well suited for a compact design and for long-term conservation of the cartridge, this storage period being able to exceed 5 years, for example being set at 10 years.

In particular, the present disclosure is more reliable when using a spring, especially a metal one, rather than foam instead of the spring. This is because the foam can compress over time and lose its ability to apply a sufficient force to the grains allowing to compact the product.

According to one of the aspects of the present disclosure, the product is retained in a filtering shell, in particular made of fabric.

According to one of the aspects of the present disclosure, the fabric is pressed against the perforations of the internal and external lateral walls.

According to one of the aspects of the present disclosure, the product is soda lime.

The present disclosure also relates to a protective hood including: a flexible shell configured to be stored in a folded state and to be put, in an unfolded state, through an open base of the flexible shell, on the head of the user, an articulated device attached to the open base and configured to be positioned around the neck of the user when the flexible shell is put on the head of the user, the articulated device comprising at least two rigid parts connected by a joint allowing these two rigid parts to transition from a folded position inhibiting the head of the user from entering the hood to an unfolded position allowing the head of the user to enter the hood, one of the rigid parts comprising the CO2 capture cartridge as described above.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic representation of a hood according to an exemplary implementation of the present disclosure, in a folded state;

FIG. 2 is a schematic representation of the hood of FIG. 1, in an unfolded state;

FIG. 3 is a schematic representation of the hood of FIG. 1, with the user spacing the articulated device in order to put on the hood;

FIG. 4 is an isolated schematic representation of the articulated device of the hood of FIG. 1;

FIG. 5 is a schematic representation of the hood of FIG. 1, put on the head of the user;

FIG. 6 is a schematic representation of a trigger member of the timer of the hood of FIG. 1;

FIG. 7 is a schematic representation of the hood of FIG. 1, stored in a bag;

FIG. 8 is a schematic representation of an alert sequence associated with the timer of the hood of FIG. 1;

FIG. 9 is a schematic representation of a cartridge for capturing CO2 to equip the protective hood of FIG. 1, with the spring in the initial position; and

FIG. 10 is a schematic representation of the cartridge for capturing CO2 of FIG. 9, with the spring in the extended position.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The features, variations, and different examples of the present disclosure may be combined with each other in various combinations, provided that they are not incompatible or mutually exclusive. In particular, variations of the present disclosure may be conceived comprising only a selection of features, described below in isolation from the other described features, if this selection of features is sufficient to confer a technical advantage and/or to differentiate the present disclosure from the prior art.

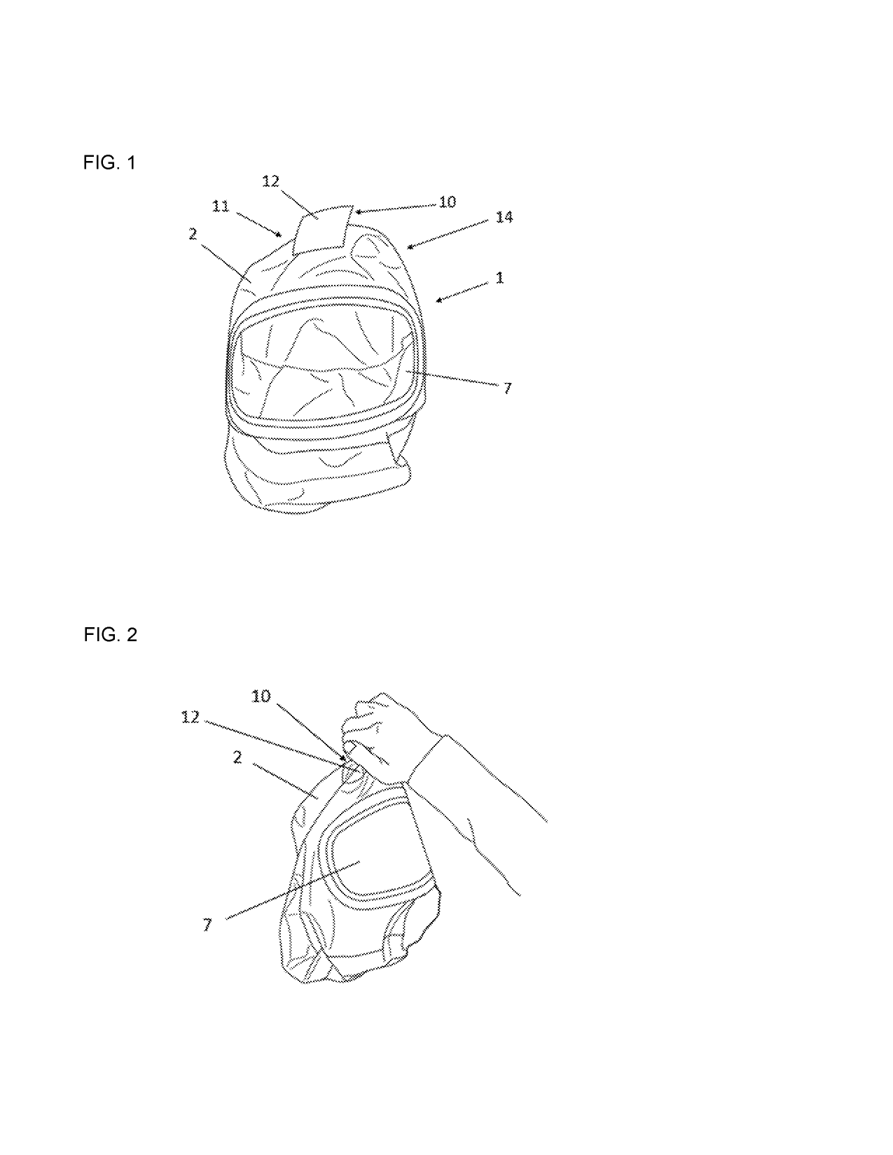

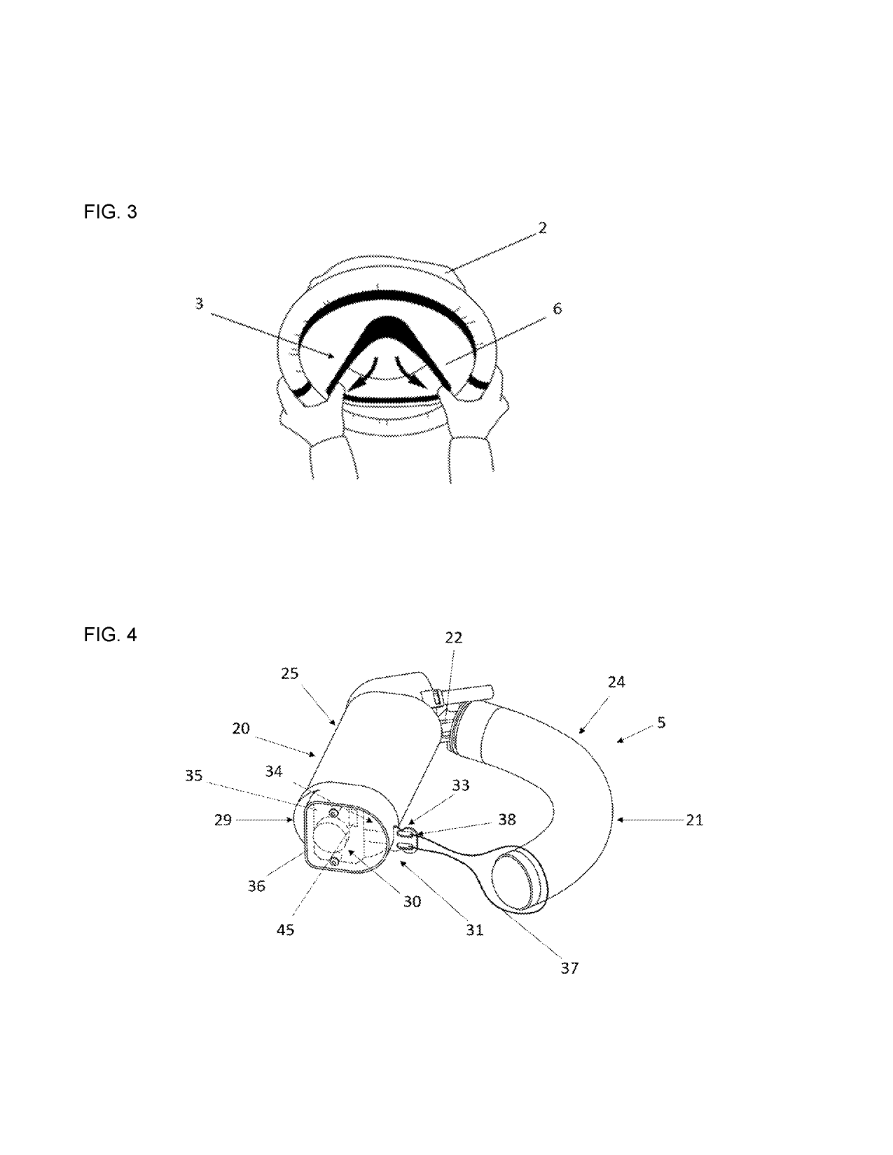

FIGS. 1 and 2 show a protective hood 1 including: a flexible shell 2 configured to be stored in a folded state (state shown in FIG. 1) and to be put on, in an unfolded state (state shown in FIG. 2), through an open base 3 of the flexible shell 2, on the head of the user U, an articulated device 5 (shown in isolation in FIG. 4) attached to the open base 3 and configured to be positioned around the neck of the user U when the flexible shell 2 is put on the head of the user.

In the described example, the flexible shell 2, which is airtight, mainly contains a Nomex® fabric and a flexible collar 6, in particular made of Neoprene®, forming the base 3.

The hood 1 further includes a semi-rigid visor 7, in particular made of transparent polymer, and possibly an acoustic membrane (not shown).

The hood 1 also includes a handle 10 attached to the flexible shell 2, this handle 10 being positioned on a top 11 of the flexible shell 2, in such a way as to be accessible to the user when the flexible shell 2 is in the folded state, as can be seen in FIG. 1.

In the described example, the handle 10 is in the form of a flexible strip 12, of substantially rectangular shape.

Other strip-shaped forms can be provided, for example a trapezoid shape or a shape with a rounded edge.

The strip-shaped handle 10 is solid, namely it is devoid of orifice. The handle 10 is devoid of loop.

The strip-shaped handle 10 is fastened to the flexible shell 2 by an edge of the strip, on an external face 14 of this flexible shell 2. For example, the handle 10 is heat-welded to the flexible shell 2.

The handle 10 is made of self-extinguishing material, namely a material which can burn in a flame, but which extinguishes itself as soon as it is removed from it.

The handle 10 may or may not be made of the same material as the flexible shell. The handle 10 could, if desired, be made as one piece with the flexible shell 2, being for example an extension of the material of the flexible shell.

Advantageously, the handle 10 has a color distinct from the color of the flexible shell 2, here being fluorescent yellow.

Thus, handle 10 is easily and very quickly identifiable by the user when he takes the folded hood 1 out of a bag. It may be desired for the equipment setup time to be less than 15 seconds.

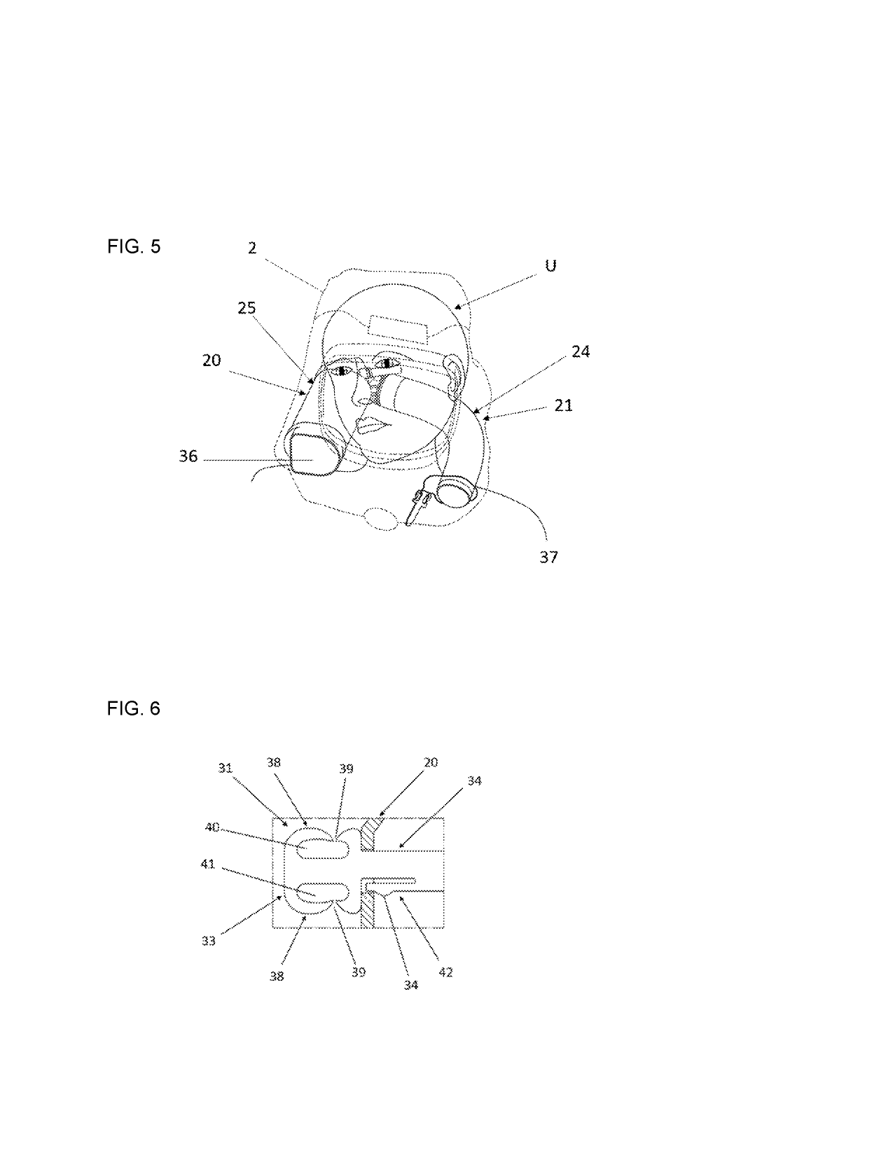

As can be seen in FIG. 4, the articulated device 5 comprises two rigid parts 20 and 21 connected by a joint 22 allowing these two rigid parts 20 and 21 to transition from a folded position (state shown in FIG. 4) inhibiting the head of the user from entering the hood 1 to an unfolded position (state shown in FIG. 5) allowing the head of the user to enter the hood 1.

The articulated device 5 has a mass of at least 50%, in particular at least 60% or 70%, of the total mass of the hood 1.

Thus, the articulated device 5, relatively heavy compared with the rest of the hood, allows reliable action to unfold the hood 1 by gravity.

The two parts 20 and 21 of the articulated device are formed by two tubular portions connected by the joint 22 to form an open ring in the unfolded position.

The articulated device 5 is configured to provide a self-contained breathing function for the user having put on the hood 1. This is the case on hoods intended for actual use, unlike hoods intended for training which may be simpler.

Thus, the articulated device 5 comprises an oxygen tank 24 formed in the tubular part 21 and provided with an oxygen outlet orifice emerging into the internal volume of the flexible shell 2.

The tubular part 20 comprises a cartridge 25 for capturing CO2, for example lime, configured to adsorb CO2 resulting from the breathing of the user.

In the described example, the tubular portion 21 which comprises the oxygen tank 24 is curved, and the tubular portion 20 which comprises the CO2 capture cartridge 25 is straight.

In the case of a training hood, which may not have the functional equipment that must equip a protective hood for real use, it can be equipped with an articulated device without a respiratory function, still allowing users to practice deploying the hood.

The tubular part 20 of the articulated device 5 includes, at its end 29 opposite to the joint 22, a timer 30 configured to be triggered when the articulated device 5 transitions from the folded position (FIG. 4) to the unfolded position (FIG. 5).

The timer 30 is equipped with a trigger member 31 configured to trigger the timer 30, this trigger member 31 being linked, on the one hand, to the timer 30 and, on the other hand, to the tubular part 21 of the articulated device 5 so that the spacing between the two parts 20 and 21 of the articulated device 5 acts on the trigger member 31 in order to trigger the timer 30.

The trigger member 31 is linked to the timer 30 in a removable manner so that the spacing of the two parts 20 and 21 of the articulated device 5 from its folded position to its unfolded position causes an extraction of the trigger member 31 from the timer 30, the extraction which results in a triggering of the timer which begins a countdown.

As can be clearly seen in FIGS. 4 and 6, the trigger member 31 includes a trigger tab 33 configured to be inserted into a slot 34 of the timer 30.

The timer 30 is configured to be in deactivated mode as long as the tab 33 is held in place.

For example, the extraction of the tab 33 makes it possible to connect the timer 30 to an electrical power source, such as a battery.

Alternatively, the trigger tab 33 is made of electrically insulating material, and is configured to keep open an electrical power supply circuit of the timer 30.

The extraction of this trigger tab 33 causes the closure of the electrical power supply circuit of the timer, and the timer starts.

The timer 30 is part of an electronic card 35.

For example, the timer 30, or the electronic card 35 which defines the timer, is mounted in a cover 36 of the CO2 capture cartridge 25.

Advantageously, the timer 30 is positioned away from the oxygen container 24 (on the other rigid part of the articulated device) which may include metal parts likely to present a risk of electric arcs.

The trigger member 31 includes at least one wire 37 connecting the removable trigger tab 33 and the opposite part 21 of the articulated device 5.

The wire 37 is configured so that, when the articulated device 5 is spaced from its folded position to its unfolded position, this wire 37 is taut and pulls the removable tab 33 to extract it from the slot 34 of the timer.

The removable trigger tab 33 comprises a double loop 38 for the passage of the wire 37.

This double loop 38 makes it possible to provide the greatest amount of material along the extraction axis of the tab 33.

The double loop 38 made of a sufficiently flexible material of the tab 33, each with a notch entry 39, makes it easy to position the wire 37 in the notch 40.

A notch 40 and a counter-notch 41 are provided to inhibit the lace from becoming dislodged from the double loop 38.

The wire 37 has a sufficient length so that, when the hood 1 is in the folded state, this wire 37 is relaxed (as can be seen in FIG. 4). Thus, no tension is exerted on the trigger tab by the wire 37.

The removable trigger tab 33 comprises a non-return member 42 configured to oppose with a predetermined force the extraction of this tab 33 from the slot 34 of the timer.

The non-return member 42, in the form of a resilient tongue, makes it possible, during assembly operations (for example folding and introduction into the pouch, and vacuum packaging), to eliminate the risk of applying force to the tab 33 likely to trigger the timer 30 unintentionally. The non-return member 42 increases the force to remove the tab 33, thus inhibits unintentional triggering.

The non-return member comprises a protrusion 43 housed in the slot 34.

In the described example, the removable trigger tab 33 is made from a plate, for example a plate of plastic material, in particular cut with a water jet.

The hood 1 is configured to provide the user with at least one item of information regarding the use of the hood based on data provided by the timer 30, this usage information being an alert indicating the end of an oxygen supply available in the articulated device 5 when the timer has measured a predetermined duration, for example a duration of 15 minutes.

The hood 1 includes a warning light 45, formed by one or more LEDs, configured to provide the user with information regarding the use of the hood. This light 45 is positioned on the electronic card 35.

The warning light 45 is controlled by the electronic card 35 to control the emission of light according to different modes.

For example, as illustrated in FIG. 8, following the triggering of the timer 30 at time T0 and after a period PS of, for example, 14 minutes, the electronic card 35 is configured to make the warning light 45 blink for a first period P1 which lasts, for example, one minute. The expiration of the first period P1 corresponds to reaching the time Tcr at which the regulatory usage time of the hood expires, which is, for example, 15 minutes. This regulatory usage time is determined by the manufacturer based on the availability of oxygen in the supply.

Then the light 45 is kept continuously on for a second period P2, for example 3 minutes, then the electronic card 35 is configured to switch off the warning light 45 at the end of the second period P2. The user must be able to remove the hood before the end of this period P2.

The present disclosure thus provides an effective alert to the user, so that he can manage the intervention time and remove the hood in time, when the oxygen supply of the hood 1 is depleted.

Other alert sequences can of course be considered, for example using another light sequence and/or a sound sequence.

The timer 30 is configured to be triggered independently of the triggering of the oxygen supply.

We will now describe a method for packaging a protective hood 1, as described above, in a vacuum bag 50, the packaging method including the following: folding the hood 1 so as to leave the handle 10 visible and accessible when the hood 1 is in the folded state, positioning the hood 1 thus folded in the bag 50, closing the bag 50.

When folding, the visor 7 is positioned on the folded flexible shell 2 (see FIG. 1) so that folds of the flexible shell are located behind the visor 7.

Preferably, the visor 7 is positioned as flat as possible or while maintaining its initial curvature against the articulated device to inhibit the occurrence of cracks in the material when it remains constrained by folding for a long storage period which can be between 10 and 15 years.

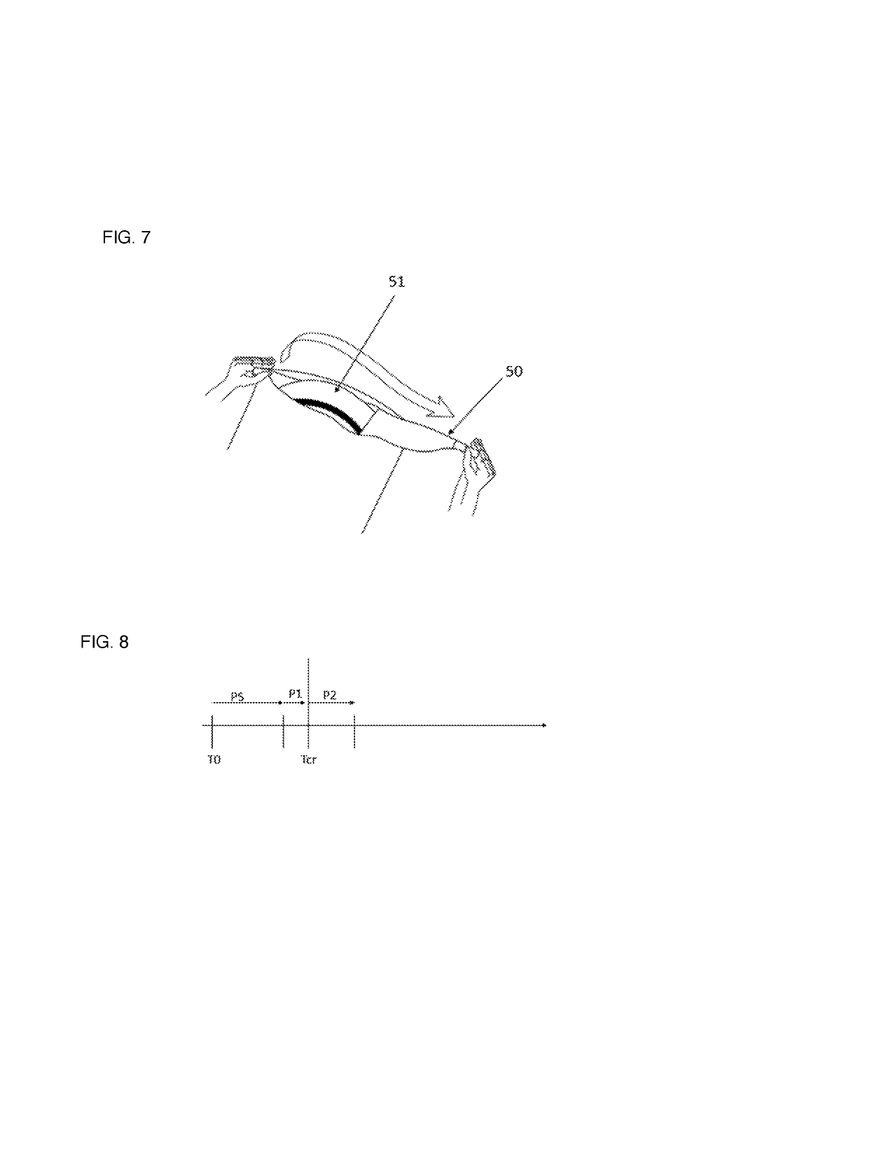

We will now describe the method for deploying a hood 1 as described above, initially stored under vacuum in a folded state in a bag 50, the method including the following: opening the bag 50 by the user U to be able to remove the hood 1 in the folded state (see FIG. 7), lifting the hood 1, initially in the folded state, using the handle 10 held by the user, in the high position, so that the flexible shell 2 can be unfolded by the action of the weight of the base of the flexible shell 2 and the articulated device 5, to move from the folded state to the unfolded state (see FIG. 2), when the flexible shell 2 is in the unfolded state, turning the hood 1 and separating the two rigid parts 20 and 21 from each other to move the articulated device 5 in the unfolded position, so that the user can put on the hood 1.

Thanks to the present disclosure, it is thus possible to deploy the hood 1 simply by holding it vertically using the handle 10, without having to shake the hood suddenly.

The timer 30 is triggered when the articulated device 5 moves from the folded position to the unfolded position during the deployment.

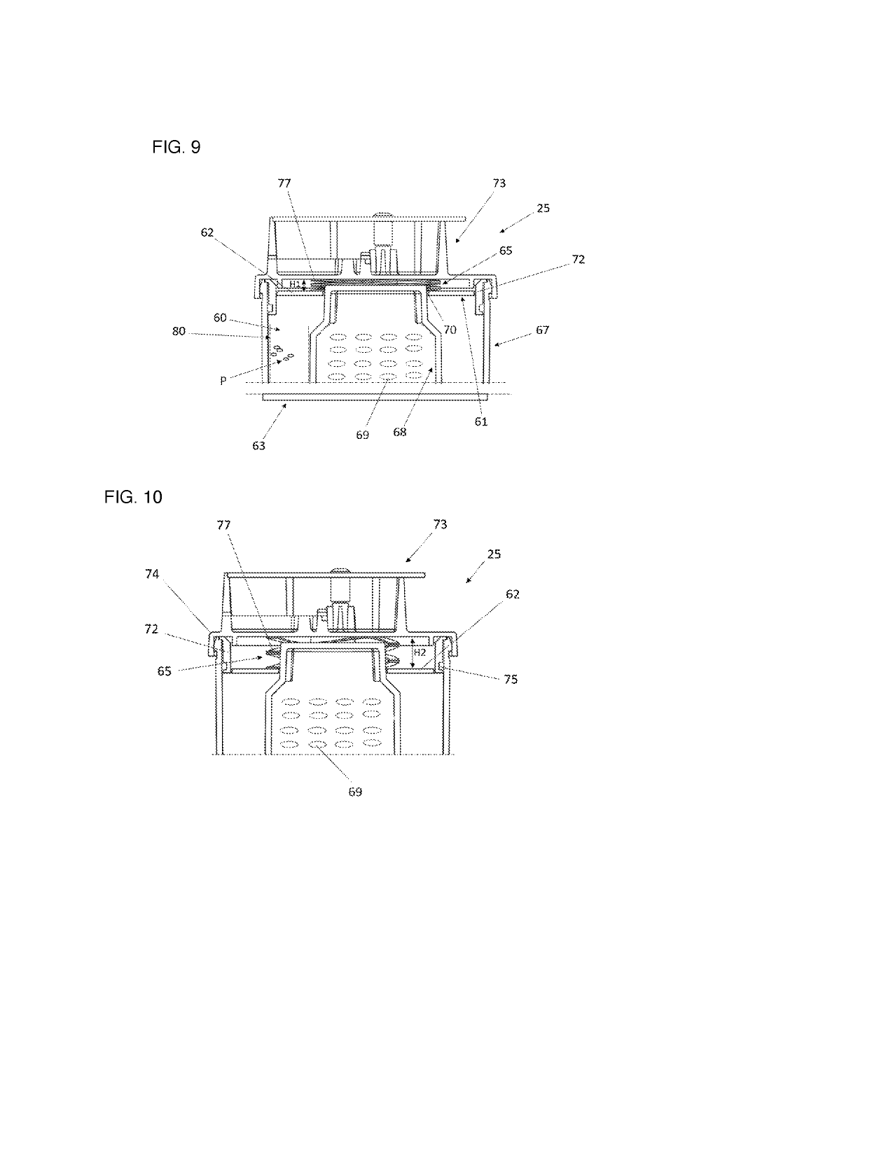

We will now describe in more detail, with reference to FIGS. 9 and 10, the CO2 capture cartridge 25 according to an example of the present disclosure.

This cartridge 25 is integrated into the rigid part 20 connected to the joint 22 described above.

The CO2 capture cartridge 25 includes a storage space 60 of an adsorbent product P capable of adsorbing CO2, this product P being soda lime in the form of grains.

The product P is retained in a filter shell 80, in particular made of fabric, placed in the storage space 60.

The storage space 60 comprising a bottom 63 and an opening 61 opposite this bottom 63.

The CO2 capture cartridge 25 further includes a compression member 62 disposed on the side of the opening 61 of the storage space 60, and which is movable in the storage space 60 towards the bottom 63 and configured to compact the adsorbent product P in the form of grains against the bottom 63 of the storage space 60.

The CO2 capture cartridge 25 further includes a spring 65 configured to exert a force on the compression member 62 tending to push the compression member 62 towards the bottom 63 of the storage space 60.

The storage space 60 is defined between an external lateral wall 67 and an internal lateral wall 68, which are coaxial.

The internal lateral wall 68 and external lateral wall 67 are provided with perforations 69 (visible in FIGS. 9 and 10 for the internal wall 68). This allows ambient CO2 to pass through the external lateral wall 67, encounter the lime grains P, be adsorbed onto the lime, and the air thus purified of CO2 then passes through the internal lateral wall 68 to be "drawn in" by a Venturi-effect device at the outlet of an internal duct of the CO2 capture cartridge 25, and returned to the internal volume of the hood 1.

The internal lateral walls 68 and external lateral walls 69 are cylindrical, with a circular or oval or oblong perimeter, and have substantially identical heights.

The product P in the form of grains is stored between the internal lateral walls 68 and external lateral walls 69. In other words, the storage space 60 has a general annular shape.

The external lateral wall 67 is formed on a cylinder.

The internal lateral wall 68 and the external lateral wall 67 are made from two separate pieces which are assembled.

The compression member 62 is a flat annular washer with a central opening 70 allowing to engage the compression member 62 around the internal lateral wall 68.

Thus the internal lateral wall 68 can serve to guide the compression member 62 during a movement of this compression member 62 in the storage space 60.

The compression member 62 is in the form of a washer inserted around the internal lateral wall 68.

The external lateral wall 67 receives, at its end bordering the opening 61, a mounting skirt 72.

The mounting skirt 72 extends over a predetermined height from the opening 61 of the storage space 60.

The compression member 62 has an outer perimeter which is fitted to the shape of this mounting skirt 72.

The cartridge 25 further includes a cover 73 configured to close the opening 61 of the storage space 60.

The cover 73 is configured to be fixed to the external lateral wall 67, and includes an annular groove 74 for fixing to the external lateral wall 67 and to the mounting skirt 72.

The mounting skirt 72 includes a groove 75 configured to receive a sealing gasket bearing against the external lateral wall 67.

The compression member 62 is made of plastic or metal.

The spring 65 is a multi-coil wave spring made of metal. The spring 65 includes a plurality of wave coils 77 stacked one on top of the other.

At the beginning of the cartridge's life (for example, when stored on board an aircraft for use), the product P in the form of grains has not yet undergone any settling due to vibrations to which the cartridge is subjected. The initial volume occupied by the product is therefore at its maximum, and the compression member 62 is located closest to the opening 61 of the storage space 60. During the product's life, vibrations can cause the grains of the adsorbent product to fragment, potentially leading to the degradation of the grains into fine particles. This reduces the volume occupied by the adsorbent product in the storage space 60. The compression member 62, which is pushed by the spring 65, moves translationally away from the opening 61 and towards the bottom 63 of the storage space 60.

It is therefore possible to define a height H1 between the compression member 62 and the cover 73, in an initial position illustrated in FIG. 9 (for example at the beginning of the life of the cartridge) in which the compression member 62 is located closest to the cover 73.

As can be seen in FIG. 10, it is also possible to define a height H2 between the compression member 62 and the cover 73 after a certain storage period of the cartridge, during which the cartridge may have been subjected to vibrations causing some settling of the adsorbent product grains. This height H2 is greater than the height H1, reflecting the fact that the compression member 62 moves in translation towards the bottom 63. This period is, for example, 10 years.

FIG. 10 shows that the coils 77 of the spring 65 have moved further apart, lengthening spring 65 to a height H2. In moving from the position shown in FIG. 9 to that shown in FIG. 10, the spring 6 has lengthened from the height H1 to height H2. The spring 65 thus changes from an initial compressed position to an elongated position.

The heights H1 and H2 are selected so that the force of the spring 65 is always greater than the weight of the adsorbent product subjected to accelerations generated by the vibrations. In particular, the stiffness of the spring 65 is selected so that, after a predetermined storage period (for example, on board an aircraft in service), the height H2 still allows the compression member 62 to provide satisfactory compaction of the adsorbent product P grains.

The compression member 62 and the spring 65 are selected so that the stroke of the compression member 62, throughout the storage period, is sufficient to maintain satisfactory compaction of the grains.

In the case where a mounting skirt 72 is inserted on the top of the external lateral wall 67, the height H2 can be selected substantially equal to the height of this mounting skirt 72 so that the compression member 62 moves opposite this mounting skirt 72, and in the event of maximum settling of the product during its service life, the compression member 62 does not move downward beyond this mounting skirt 72.

In the described example, the spring 65 is simply placed on the compression member 62.

The spring 65 has coils which are positioned around the internal lateral wall 68.

The spring 65 bears at one end against the cover 73 and at the other end against the compression member 62.

The spring 65 is a separate part from the compression member 62, which are for example made of different materials.

Alternatively, the spring 65 and the compression member 62 are integrally formed i.e. in one piece.

The wave spring 65 with the multiple coils 77 of metal is particularly well suited to a compact design and a long-term storage of the cartridge 25, this storage period being able to exceed 5 years, for example by being set at 10 years.

In particular, the present disclosure is more reliable with the use of a spring 65, in particular made of metal, rather than a foam instead of the spring 65. Indeed, the foam can compress over time and lose its ability to apply a sufficient force to the grains allowing to compact the product.

In one variant of the present disclosure, the rigid part 20 which comprises the cartridge 25 may be devoid of the timer 30 and the triggering device described above.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A CO2 capture cartridge configured to adsorb CO2 resulting from a respiration of a user, the cartridge including:
a storage space for an adsorbent product (P) capable of adsorbing the CO2, the adsorbent product defined as grains and composed of soda lime, the storage space including a bottom and an opening opposite the bottom;
a compression member disposed on a side of the opening of the storage space, the compression member movable within the storage space towards the bottom and configured to compress the adsorbent product against the bottom of the storage space; and
a spring configured to exert a force on the compression member to push the compression member towards the bottom of the storage space.

2. The cartridge according to claim 1, wherein the storage space is defined between an external lateral wall and an internal lateral wall, and the internal lateral wall and the external lateral wall are perforated.

3. The cartridge according to claim 2, wherein the compression member has an annular shape with a central opening configured to engage the compression member around the internal lateral wall, and the compression member is a washer inserted around the internal lateral wall.

4. The cartridge according to claim 1, further including a cover configured to close the opening of the storage space, and the spring is configured to bear at one end against the cover and at another end against the compression member.

5. The cartridge according to claim 1, wherein the compression member is comprised of plastic or metal.

6. The cartridge according to claim 1, wherein the spring is a multi-coil wave spring composed of metal.

7. The cartridge according to claim 1, wherein the compression member and the spring are selected such that a stroke of the compression member, throughout a storage period, is configured to maintain compaction of the adsorbent product.

8. The cartridge according to claim 1, wherein the spring is separate from the compression member, and the spring and the compression member are composed of different materials.

9. The cartridge according to claim 1, wherein the adsorbent product is retained in a filter shell composed of fabric.

10. A protective hood including:
a flexible shell configured to be stored in a folded state and to be put, in an unfolded state, through an open base of the flexible shell, on a head of a user; and
an articulated device secured to the open base and configured to be positioned around a neck of the user when the flexible shell is put on the head of the user, the articulated device comprising at least two rigid parts connected by a joint, the joint configured to facilitate a movement of the at least two rigid parts from a folded position inhibiting the head of the user from entering the protective hood to an unfolded position allowing the head of the user to enter the protective hood, and one of the at least two rigid parts comprises the CO2 capture cartridge according to claim 1.
